(19) United States
(12) Patent Application Publication
(10) Pub. No.: US 2009/0277593 A1
(43) Pub. Date: Nov. 12, 2009

(54) ACOUSTIC WINDOW SHADE

(76) Inventor: Grant W. STEWART, Cincinnati, OH (US)

Correspondence Address: Hasse & Nesbitt LLC, 8837 Chapel Square Drive, Suite C, CINCINNATI, OH, 45249, US

(21) Appl. No.: 12/432,312

(22) Filed: Apr. 29, 2009

Related U.S. Application Data
(60) Provisional application No. 61/051,969, filed on May 9, 2008.

(51) Int. Cl. E06B 9/56; E06B 9/42

(52) U.S. Cl. 160/127; 160/311

(57) ABSTRACT

A window shade for use with a window shade system comprising an operable roller for rolling and unrolling the shade. The window shade comprises a flexible sheet that comprises a decorative fabric layer and a sound attenuating layer, such as a polymer film with filler material or mass loaded vinyl. The window shade system comprises an operable roller mounted at the top portion of the window opening; first and second side casings attached to respective sides of the window opening, each side casing forming a channel for receiving respective first and second opposing side edges of a window shade. Typically, the shade system also comprises a motor operatively connected to the roller such that the roller rotates about its longitudinal axis in response to the operation of the motor. The shade system may also comprise a second roller and second window shade comprising a decorative fabric layer, and optionally a sound attenuating layer.

### CROSS-REFERENCE TO RELATED APPLICATIONS

This application claims the benefit of co-pending U.S. Provisional Application No. 61/051,969, filed May 9, 2008.

### FIELD OF THE INVENTION

This invention relates to acoustic window shades. More particularly, the invention relates to a window shade for use on a shade roller, the shade comprising a sheet having a decorative fabric layer and a sound attenuating layer. The invention also relates to window shade systems comprising such acoustic shades

### BACKGROUND OF THE INVENTION

Window shade systems are desirable to reduce or eliminate light from entering a room through a window or a skylight, particularly in a home theater or a conference room used for film viewing. Numerous shade systems are disclosed in the art. Typically, the shades of such systems are unrolled from a roller in a casing affixed to the top of the window opening. The roller may be controlled by a motor inside the casing, a manually operated crank, or a bi-directional clutch having a chain affixed thereto. The shade may comprise various materials and have varied textures and light admitting properties. Shade systems are disclosed in, for example, U.S. Pat. Nos. 5,323,831; 5,467,266; and 5,848,634.

In a home theater or conference room setting, the quality of sound from both the presentation itself and the immediate environment is important to the listener's genuine enjoyment and appreciation of the presentation. The benefits of a quality sound system in a home theater or conference room can be reduced by sound bouncing back into the listening space from walls and windows, and by outside sound coming into the environment through windows. When radiant sound can be absorbed in such areas, rather than echoing back in conflict with sounds from the presentation, negative issues can be reduced or eliminated altogether. This is sometimes achieved by covering walls and windows with an acoustically absorbent material. Walls are often also widened with extra insulation and double sheet rock to form a sound barrier from external noise. In the case of windows, heavy draperies or window shades having soft or thick fabrics may aid in sound absorption, although shades using industry standard fabrics and materials typically have little or no measurable effect. Window shading also provides outside light control or blockage, which is important to appreciate visual aspects of a presentation. Window roller shades are generally more practical and desirable than draperies, primarily because of physical space limitations and aesthetic tastes or requirements. Additionally, window roller shades tend to allow better control of outside light because of more latitude in positioning shades and fabric options.

In view of the above, it would be desirable to provide a window shade and system for home theaters and conference rooms that would measurably reduce both the echo effect of sound bouncing back into the listening space from walls and windows and outside sound coming into the environment through the windows.

### SUMMARY OF THE INVENTION

The present invention relates to a window shade for use with a window shade system comprising an operable roller for rolling and unrolling the shade, the shade comprising a flexible sheet of a size which at least substantially covers the window opening, the sheet having a top edge for connection to the roller, a bottom edge opposite the top edge, and first and second opposing side edges defining the width of the sheet, the sheet comprising a decorative fabric layer and a sound attenuating layer.

The invention also relates to window shade system for disposition within a window opening in a room, the opening having top and bottom portions and first and second opposing sides, the system comprising a) an operable roller mounted at the top portion of the window opening; b) first and second side casings attached to the respective first and second sides of the window opening, each side casing forming a channel for receiving respective first and second opposing side edges of a window shade for use therewith; and c) a window shade comprising a flexible sheet of a size which at least substantially covers the window opening, the sheet having a top edge connected to the roller and being movable between a rolled condition and an unrolled condition, a bottom edge opposite the top edge, and first and second opposing side edges for disposition within the channels formed by the side casings when the sheet is in the unrolled condition, the first and second opposing side edges defining the width of the sheet, the sheet comprising a decorative fabric layer and a sound attenuating layer.

In one embodiment, the above window shade system further comprises a motor operatively connected to the roller such that the roller rotates about its longitudinal axis in response to the operation of the motor.

In yet another embodiment, the invention provides a window shade system for disposition within a window opening in a room, the opening having top and bottom portions and first and second opposing sides, the system comprising:

a) an operable roller mounted at the top portion of the window opening;

b) a motor operatively connected to the roller such that the roller rotates about its longitudinal axis in response to the operation of the motor;

c) first and second side casings attached to the respective first and second sides of the window opening, each side casing forming a channel for receiving respective first and second opposing side edges of a window shade for use therewith;

d) a window shade comprising a flexible sheet of a size which at least substantially covers the window opening, the sheet having a top edge connected to the roller and being movable between a rolled condition and an unrolled condition, a bottom edge opposite the top edge, and first and second opposing side edges for disposition within the channels formed by the side casings when the sheet is in the unrolled condition, the first and second opposing side edges defining the width of the sheet, the sheet comprising a decorative fabric layer and a sound attenuating layer; and

e) a second operable roller mounted at the top portion of the window opening, a second motor operatively connected to the second roller such that the roller rotates about its longitudinal axis in response to the operation of the motor, and a second window shade comprising a flexible sheet of a size which at least substantially covers the window opening, the sheet having a top edge connected to the second roller and being movable between a rolled condition and an unrolled condition, a bottom edge opposite the top edge, and first and second opposing side edges defining the width of the sheet, the sheet comprising a decorative fabric layer.

### BRIEF DESCRIPTION OF THE DRAWINGS

FIG. 1 is a perspective view of a window shade and system of the invention.

FIG. 2 is an exploded perspective view of the window shade and system of FIG. 1.

FIG. 3 is an end view of the window shade and system of FIG. 1.

### DETAILED DESCRIPTION OF THE INVENTION

The window shade of the present invention is designed for use with a window shade system comprising an operable roller for rolling and unrolling the shade. The window shade comprises a flexible sheet of a size which at least substantially covers the window opening. The sheet has a top edge for connection to the roller, a bottom edge opposite the top edge, and first and second opposing side edges defining the width of the sheet. The sheet comprises a decorative fabric layer and a sound attenuating layer. These and other features of the invention will be explained with reference to the accompanying drawings, which illustrate non-limiting embodiments of the invention.

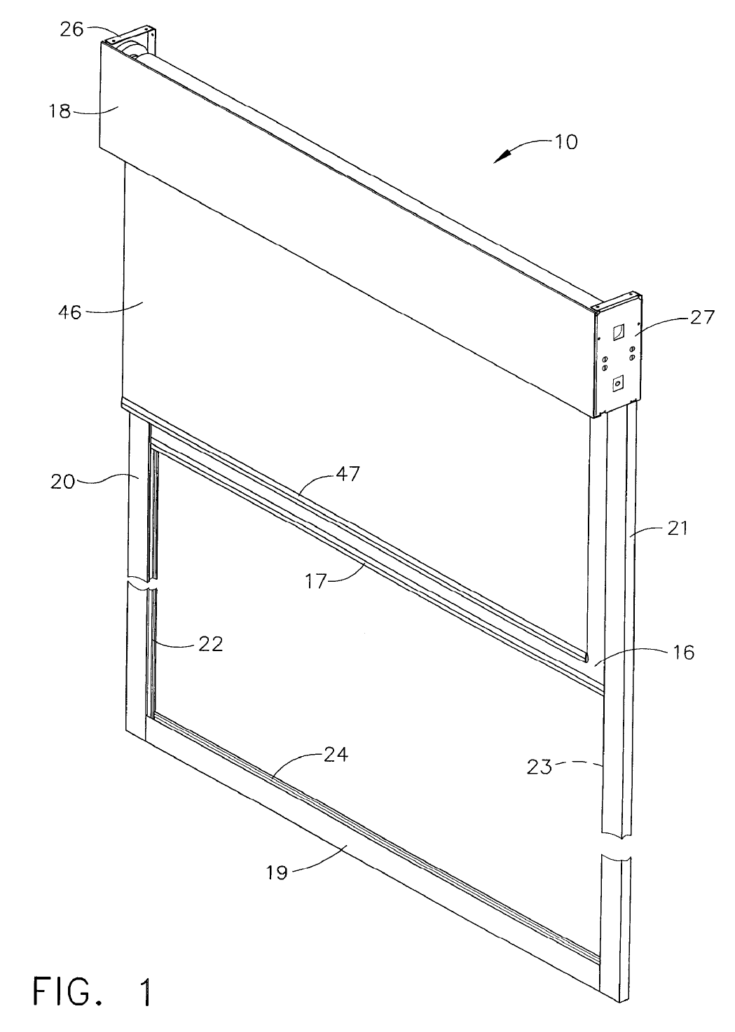

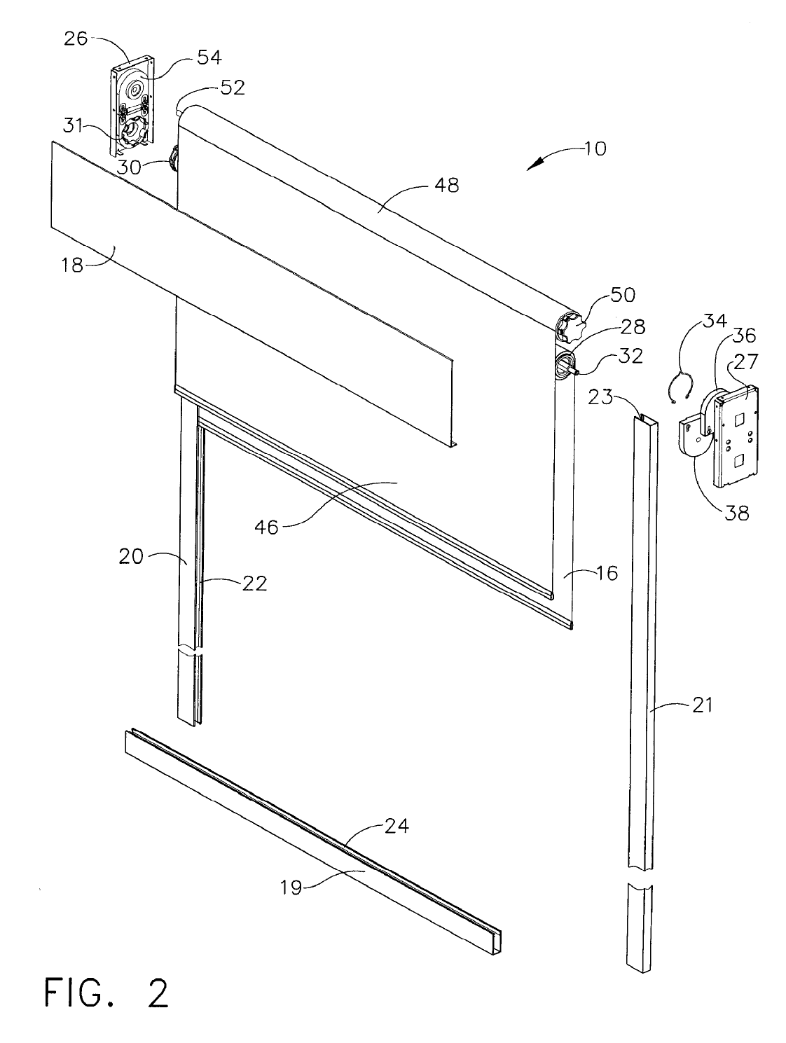

FIG. 1 is a perspective view of a window shade system 10 of the invention installed within a window opening having a top portion, a bottom portion opposite the top portion, and first and second opposing sides. Shade system 10 includes top casing 18, bottom casing 19, and first and second side casings 20 and 21, each casing being mounted to the respective portion or side of the window opening. Shade system 10 also includes first and second mounting brackets 26 and 27 for encasing the motor and roller assembly and to aid in mounting them to the first and second opposing sides of the window opening. Shade system 10 includes a shade comprising flexible sheet 16, which has a top edge for connection to the roller, a bottom edge opposite the top edge, and first and second opposing side edges defining the width of the sheet. Sheet 16 can be raised and lowered from top casing 18 such that the first and second opposing side edges of sheet 16 are slidably movable within channel 22 of first casing 20 and channel 23 of second casing 21 (see FIG. 2). The bottom edge of sheet 16 is defined by hem bar 17, which provides a weight to keep the sheet taut. When sheet 16 is fully lowered to engage bottom casing 19, hem bar 17 resides within channel 24 of bottom casing 19. Sheet 16 is sized to substantially cover the window opening.

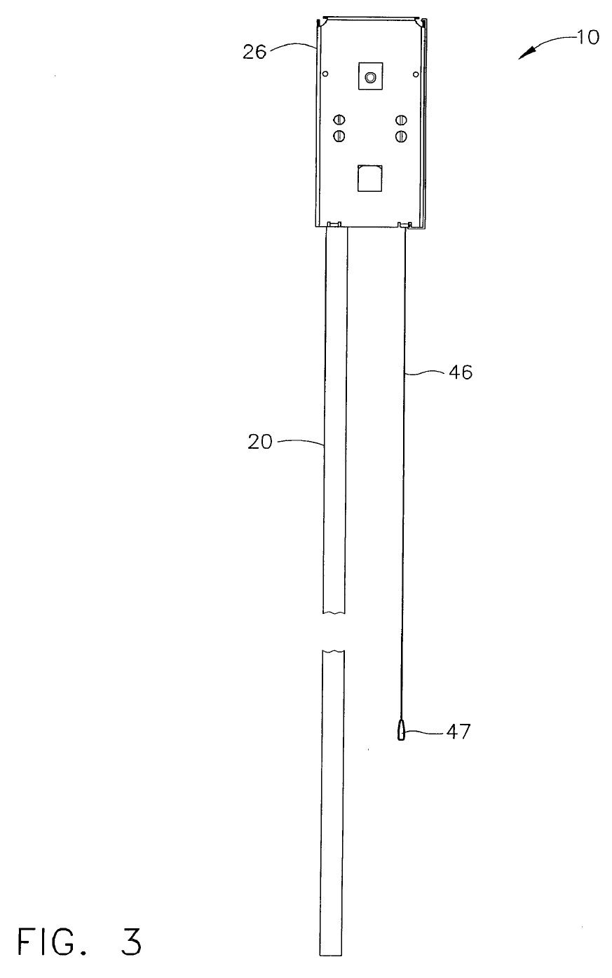

In the embodiment shown in FIG. 1, window shade system 10 further comprises a second shade comprising flexible sheet 46, which also has a top edge for connection to the roller, a bottom edge opposite the top edge, and first and second opposing side edges defining the width of the sheet. Sheet 46 is raised and lowered from top casing 18 such that the first and second opposing side edges of sheet 46 are outside of first casing 20 and second casing 21, i.e., shade 46 is free-hanging. This can be seen in FIG. 3, which is an end view of the window shade and system of FIG. 1 showing sheet 46 hanging outside of and removed from first casing 20. Although not shown, sheet 16 is contained within channel 22 of first casing 20. The bottom edge of sheet 46 is defined by hem bar 47, which provides a weight to keep the sheet taut. When sheet 46 is fully lowered, hem bar 47 is outside of channel 24 of bottom casing 19. Sheet 46 is sized to substantially cover the window opening, and typically is the same size as sheet 17. In another embodiment of the invention, the second shade comprising sheet 46 may be slidably movable within channels of another set of side casings such as first casing 20 and second casing 21. In such a case, when the sheet is fully lowered, it may engage another bottom casing such as bottom casing 19, and its hem bar may reside within a channel of the bottom casing.

FIG. 2 is an exploded view of the window shade and system of FIG. 1. Although not shown, the top edge of sheet 16 is attached to roller 28 using means known in the art, for example by using adhesive tape, double-sided adhesive tape, glue, staples, screws or other fasteners. Roller 28 may be made from any material that is sufficiently rigid to support the weight of a sheet 16, such as aluminum, steel, or carbon composite. Roller 28 is cut to an appropriate length depending on the size of the window opening. In one embodiment, the roller is a section of 2-2.25 inch diameter aluminum alloy tubing. In large window applications, the tube diameter may be as large as 4-8 inches, or more.

Roller 28 is operatively connected to motor 30 such that roller 28 rotates about its longitudinal axis in response to the operation of the motor. In this manner, rotation of roller 28 by motor 30 causes sheet 16 to be raised and lowered with respect to top casing 18. Thus, sheet 16 is movable between a rolled condition in which the sheet is rolled about roller 28 and an unrolled condition in which the sheet substantially covers the window opening. Motor 30 is connected to motor bracket 31 (similar to motor bracket 36) through a motor retaining ring (not shown, but similar to retaining ring 34). The motor end of roller 28 is mounted to one side of the window opening through motor bracket 31 and mounting bracket 26. The idler end 32 of roller 28 is mounted to the other side of the window opening through idler bracket 38 and mounting bracket 27.

As also shown in FIG. 2, sheet 46 is attached to roller 48, using means known in the art and as described above. Roller 48 may be made from any material that is sufficiently rigid to support the weight of a sheet 46, such as aluminum, steel, or carbon composite, and is cut to an appropriate length depending on the size of the window opening. In one embodiment, the roller is a section of 2-2.2 inch diameter aluminum alloy tubing. In large window applications, the tube diameter may be as large as 4-8 inches, or more.

Roller 48 is operatively connected to motor 50 such that roller 48 rotates about its longitudinal axis in response to the operation of the motor. In this manner, rotation of roller 48 by motor 50 causes sheet 46 to be raised and lowered with respect to top casing 18. Thus, sheet 46 is movable between a rolled condition in which the sheet is rolled about roller 48 and an unrolled condition in which the sheet substantially covers the window opening. Motor 50 is connected to motor bracket 36 through motor retaining ring 34. The motor end of roller 48 is mounted to one side of the window opening through motor bracket 36 and mounting bracket 27. The idler end 52 of roller 48 is mounted to the other side of the window opening through idler bracket 54 (similar to idler bracket 38) and mounting bracket 26.

Motors 30 and 50 may receive control signals from any suitable source such as an infrared (IR) or radio frequency (RF) remote control or a low-voltage wall control as will be later described. The motors are typically powered from a conventional 120 volt ac wall receptacle, and may be hardwired within a junction box, or to a building distribution panel, or through a 120:24 transformer.

The window shade system herein can be mounted adjacent to or within any window opening, including a skylight opening, in a wall, ceiling and the like. It can be disposed at an angle to horizontal or vertical. In such angled or horizontal applications, the shade hardware can be modified to meet design requirements, as known in the art. A single window shade system is shown in the drawings, but multiple shade systems can be mounted side-by-side, for example over a corresponding group of adjacent windows. It will also be appreciated that other mechanisms, such as a hand crank or a bi-directional clutch, may be utilized for raising and lowering the shade, and that such mechanisms are within the scope of the present invention.

In the window shade of the present invention, the flexible sheet comprises a decorative fabric layer and a sound attenuating layer. The sheet typically has a thickness of from about 0.01 inches to about 0.25 inches, more typically from about 0.02 inches to about 0.1 inches. The decorative fabric layer may be any suitable fabric, and typically has a size up to about 3.3 meters by 3.3 meters with a maximum fabric weight per motor of about 4.5 kilograms. Of course, larger fabric sizes may be accommodated by means of a motor drive unit capable of generating more torque. A suitable fabric is standard stock from 3G Mermet, although other similar fabrics can be used. In another embodiment, the decorative fabric layer is a perforated fabric commercially available as View from Sunbrella/Glenraven Industries. The fabric layer may comprise one or more nonwoven fibrous sheets or other suitable materials, as a single-layered or multiple-layered laminate-type composite.

The sound attenuating layer may comprise a polymer matrix, for example a polymer film, and a filler material, such as disclosed in WO 2008/021455 A2, incorporated herein by reference. The matrix material may include polymers and polymeric resins, aerogels, nonwoven fibrous materials, or combinations of the foregoing. Suitable polymers and polymeric resins may include polymers currently used for sound absorption applications such as open celled foamed polymers, polyurethanes, polyimides, polycyanurates, polyesters and melamine.

Other suitable polymer and polymeric resins include, but are not limited to, polystyrene, polyurethane, polyolefins such as polyethylene or polypropylene, hydrogels, polyacrylates, polyarylenes, polycarbonates, polyureas, polycyanurates, polysulfones, epoxies, nylons, aramids, polyvinyl chloride, polymers of (meth)acrylic acid or the esters and/or salts of (meth)acrylic acid, polyesters, rubber, PTFE, silicone, and mixtures of two or more of any of the foregoing. The polymer may also be a polymer of one or more of the monomers comprising the polymers of the foregoing. For example, the polymer may be a copolymer of styrene and acrylonitrile.

Another polymer medium that can be used is hydrogel. Hydrogel is a network of polymer chains that are water-soluble, sometimes found as a colloidal gel in which water is the dispersion medium. Hydrogels can be created in may ways, and is not limited to any one particular method of formation. For example, the hydrogels may be made of one or more materials selected from the group consisting of polyvinyl alcohol, sodium polyacrylate, (meth)acrylate polymer, and other polymers with an abundance of hydrophilic groups. Preferred hydrogels include 2-hydroxyethylmethacrylate (HEMA) hydrogels, but are not limited thereto. Another suitable hydrogel material includes N-vinyl-pyrrolidone (NVP).

Cross linkers may also be used in the polymers. For example, ethylene glycol dimethacrylate (EDGMA) may be used. Another example of a cross linker is polyethylene glycol dimethacrylate (PEDGMA). Photoinitiators, such as 2,2-dimethoxy-2-phenyl acetophenone, may also be used. In some embodiments, the photoinitiator may help assist in the reaction of the polymerization and/or curing of the polymers. For example, UV irradiation of a polymer comprising 2,2-dimethoxy-2-phenyl acetophenone results in the curing of the polymer composite material.

Filler materials herein include a non-reactive material with a high density, typically greater that 1 g/cm³, and more typically from about 2.0 to about 3.0 g/cm³. The filler material may be chosen for any non-reactive material with a high density such as, for example, barium sulphate, kaolin clay, silica, mica, microscopic hollow glass beads, or mixtures thereof.

In another embodiment, the sound attenuating layer comprises a mass-loaded vinyl material. Such materials are commercially available and can be made in varying levels of opacity (clear, semi-opaque or non-transparent), as desired, for more or less light transmission into the structures. A suitable material is American Mass Loaded Vinyl, distributed by Soundproofing America. Those skilled in the art will understand that many types of materials may be used.

In one embodiment, the sheet is a laminate of the decorative fabric layer and the sound attenuating layer. In another embodiment, the sound attenuating layer may be coated onto the decorative fabric layer, for example, by spraying, coating, or otherwise depositing a slurry, solution, emulsion, or mixture of the sound attenuating material onto the fabric and then drying the fabric to remove water and/or solvents, or simply allowing the material to cool and solidify. In another embodiment, the sound attenuating layer may be deposited or laminated as a thin film onto the fabric layer, and then dried or allowed to solidify, as required. Pressure, or a combination of heat and pressure, may be applied to form a laminate, and ultra violet (UV) light may be used as necessary to aid curing or chemical reactions. The above processes may be performed manually. For example, the decorative fabric layer and an acoustic film may be cut to the desired size, and an adhesive applied to each layer using a brush, roller applicator or spray-gun. A suitable adhesive is Weldwood Contact Cement, commercially available from DAP. The layers are then joined together on a bench or work table. The laminate can then be rolled or pressed under pressure using a hand-held rolling device, and left to dry or cure as required. More typically, the above processes are performed using automated equipment designed for such purposes. In an automated process, the laminated sheet may be produced on a bulk, large roll basis, and cut to custom sizes for specific shades as needed.

The window shades and shade systems of the invention provide improved ambient sound absorption due to the acoustical sheet herein, which traps unwanted sound coming in from outside the window area. The invention thus provides a measurable reduction in noise coming into the room through windows in which the acoustic shade is installed. The window shades and shade systems herein also trap unwanted sound inside the room due to the echo effect of sound bouncing back into the listening space from walls and windows. Embodiments of the invention using two separate window shades and a dual roller system may further improve acoustical properties by taking advantage of the air space between the two shades, which has a proven acoustical benefit as well. The window shades and shade systems herein thus provide advantages over conventional roller shade systems for home theater or conference room applications by improving overall room acoustics, in addition to providing traditional light control. The window shades and shade systems herein may also provide aesthetic and other benefits relating to their style, ease of installation, independent control compatibility, and simple mechanical design that limits inherent noise levels during operation.

While particular embodiments of the invention have been described, the invention can be further modified within the spirit and scope of this disclosure. This application is therefore intended to cover any variations, uses or adaptations of the invention using its general principles. Further, the application is intended to cover such departures from the present disclosure as come within known or customary practice in the art to which this invention pertains and which falls within the limits of the appended claims.

What is claimed is:

1. A window shade for use with a window shade system comprising an operable roller for rolling and unrolling the shade, the shade comprising a flexible sheet of a size which at least substantially covers the window opening, the sheet having a top edge for connection to the roller, a bottom edge opposite the top edge, and first and second opposing side edges defining the width of the sheet, the sheet comprising a decorative fabric layer and a sound attenuating layer.

2. The shade of claim 1 wherein the sound attenuating layer comprises a polymer matrix and a filler material.

3. The shade of claim 2 wherein the filler material comprises barium sulfate, kaolin clay, silica, mica, microscopic hollow glass beads, or mixtures thereof.

4. The shade of claim 1 wherein the sound attenuating layer comprises mass loaded vinyl.

5. The shade of claim 1 wherein the sheet has a thickness of from about 0.01 inches to about 0.25 inches.

6. A window shade system for disposition within a window opening in a room, the opening having top and bottom portions and first and second opposing sides, the system comprising:
a) an operable roller mounted at the top portion of the window opening;
b) first and second side casings attached to the respective first and second sides of the window opening, each side casing forming a channel for receiving respective first and second opposing side edges of a window shade for use therewith; and
c) a window shade comprising a flexible sheet of a size which at least substantially covers the window opening, the sheet having a top edge connected to the roller and being movable between a rolled condition and an unrolled condition, a bottom edge opposite the top edge, and first and second opposing side edges for disposition within the channels formed by the side casings when the sheet is in the unrolled condition, the first and second opposing side edges defining the width of the sheet, the sheet comprising a decorative fabric layer and a sound attenuating layer.

7. The system of claim 6 further comprising a motor operatively connected to the roller such that the roller rotates about its longitudinal axis in response to the operation of the motor.

8. The system of claim 6 further comprising a top casing mounted to the top portion of the window opening, the top casing housing the roller and the motor, and a bottom casing mounted to the bottom portion of the window opening, the bottom casing forming a channel for receiving the bottom edge of the sheet.

9. The system of claim 6 wherein the sound attenuating layer comprises a polymer matrix and a filler material.

10. The system of claim 9 wherein the filler material comprises barium sulfate, kaolin clay, silica, mica, microscopic hollow glass beads, or mixtures thereof.

11. The system of claim 6 wherein the sound attenuating layer comprises mass loaded vinyl.

12. The system of claim 6 wherein the sheet has a thickness of from about 0.01 inches to about 0.25 inches.

13. The system of claim 12 wherein the sheet has a thickness from about 0.02 inches to about 0.1 inches.

14. The system of claim 6 further comprising a second operable roller mounted at the top portion of the window opening, and a second window shade comprising a flexible sheet of a size which at least substantially covers the window opening, the sheet having a top edge connected to the second roller and being movable between a rolled condition and an unrolled condition, a bottom edge opposite the top edge, and first and second opposing side edges defining the width of the sheet, the sheet comprising a decorative fabric layer.

15. The system of claim 14 further comprising a second motor operatively connected to the second roller such that the roller rotates about its longitudinal axis in response to the operation of the motor.

16. The system of claim 15 further comprising a top casing mounted to the top portion of the window opening, the top casing housing the first and second rollers and the first and second motors, and a bottom casing mounted to the bottom portion of the window opening, the bottom casing forming a channel for receiving the bottom edge of the sheet.

17. The system of claim 16 wherein the sound attenuating layer comprises a polymer matrix and a filler material.

18. The system of claim 17 wherein the sound attenuating layer comprises mass loaded vinyl.

19. The system of claim 18 wherein each sheet has a thickness of from about 0.01 inches to about 0.25 inches.

20. A window shade system for disposition within a window opening in a room, the opening having top and bottom portions and first and second opposing sides, the system comprising:
a) an operable roller mounted at the top portion of the window opening;
b) a motor operatively connected to the roller such that the roller rotates about its longitudinal axis in response to the operation of the motor;
c) first and second side casings attached to the respective first and second sides of the window opening, each side casing forming a channel for receiving respective first and second opposing side edges of a window shade for use therewith;
d) a window shade comprising a flexible sheet of a size which at least substantially covers the window opening, the sheet having a top edge connected to the roller and being movable between a rolled condition and an unrolled condition, a bottom edge opposite the top edge, and first and second opposing side edges for disposition within the channels formed by the side casings when the sheet is in the unrolled condition, the first and second opposing side edges defining the width of the sheet, the sheet comprising a decorative fabric layer and a sound attenuating layer; and
e) a second operable roller mounted at the top portion of the window opening, a second motor operatively connected to the second roller such that the roller rotates about its longitudinal axis in response to the operation of the motor, and a second window shade comprising a flexible sheet of a size which at least substantially covers the window opening, the sheet having a top edge connected to the second roller and being movable between a rolled condition and an unrolled condition, a bottom edge opposite the top edge, and first and second opposing side edges defining the width of the sheet, the sheet comprising a decorative fabric layer.

21. The system of claim 20 further comprising a top casing mounted to the top portion of the window opening, the top casing housing the first and second rollers and the first and second motors, and a bottom casing mounted to the bottom portion of the window opening, the bottom casing forming a channel for receiving the bottom edge of the sheet.

22. The system of claim 21 wherein the sound attenuating layer comprises a polymer matrix and a filler material.

23. The system of claim 21 wherein the sound attenuating layer comprises mass loaded vinyl.
